(19) United States
(12) Patent Application Publication
(10) Pub. No.: US 2024/0064369 A1
(43) Pub. Date: Feb. 22, 2024

(54) APPARATUS AND METHOD FOR CONTROLLING TUNERS IN A CONTENT DISTRIBUTION SYSTEM

(71) Applicant: Thomson Licensing, Cesson Sevigne Cedex (FR)

(72) Inventors: Steven Charles RHOADS, Carmel, IN (US); Doug STRACHOTA, Indianapolis, IN (US)

(21) Appl. No.: 18/269,602

(22) PCT Filed: Dec. 21, 2021
(86) PCT No.: PCT/EP2021/087050

§ 371 Date: Jun. 26, 2023

Related U.S. Application Data
(60) Provisional application No. 63/132,846, filed on Dec. 31, 2020.

(51) Int. Cl. H04N 21/4363; H04N 21/214; H04N 21/426; H04N 21/2381

(52) U.S. Cl. CPC H04N 21/4363; H04N 21/2143; H04N 21/4263; H04N 21/2381

(57) ABSTRACT

A method and apparatus for controlling tuners in a content distribution system is described. The method and apparatus receive a request from a user device for a program stream over a local network at a receiver device that includes a join request at a network address. The method and apparatus further identify a channel associated with the network address, the channel being one of the channels received by the receiver device from a content service provider. The method and apparatus also determine if the identified channel is already tuned by a tuner in the receiver device. The method and apparatus additionally tune the channel using a tuner not currently being used if it is determined that the identified channel is not already tuned and provide the program stream from the tuned channel at the network address to the user device.

### FIELD

The present disclosure generally relates to communication systems, and more particularly, to a method and apparatus for managing the tuning of channels, such as broadcast channels from a service provider, and providing content from the channels over a local network based on user requests as part of a content distribution system.

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

There are many situations where a signal re-broadcasting arrangement may be used to service the media content needs of a large facility or environment. Such a rebroadcasting arrangement may provide large scale multichannel reception of a plurality of channels provided by a content service provider and redistribute at least some of those channels, sometimes in a different format, over a local network to user devices, such as televisions and settop boxes that are located throughout the environment. Hotels, resorts, senior living facilities, nursing homes, and apartment complexes, along with dining establishments, casinos, sports bars, and medical/dental facilities are a few examples of such an environment, but many others such examples also exist. Such an environment exists when it is desirable to send different channels or subchannels to different places in the environment, but for cost, efficiency or other reasons, only a limited number of signal receivers are provided.

One such signal re-broadcasting arrangement, although there are many possible arrangements, is a content distribution system. A content distribution system may include a signal receiver device, or local head-end device, capable of simultaneously tuning and decoding a plurality of channels of program content included in the received broadcast signal. The content distribution system further provides the program content as program streams to be redistributed through a local communication network to a set of user devices in the environment. In some cases, the program streams may be reformatted for delivery as a new set of channels using transmission circuits in the multichannel transmission device. These new channels may be delivered over a radio frequency (RF) network, similar to a cable television network. The program streams may also be re-formatted as internet protocol streams for delivery over a local data network such as an Institute of Electrical and Electronics Engineers (IEEE) standard 802.3 network, often referred to as an Ethernet network.

One advantage of a content distribution system is that the size of the system, including the number of channels tuned, and/or the number of channels provided to user devices, may be scaled based on specific needs or requirements for the environment or facility, as well as cost. In many arrangements the decisions for which channels are made available to user devices is controlled by the proprietor or manager of the environment or facility. Even if the content distribution system is capable of providing channels both over an RF network and an Ethernet network, often the limiting factor is how many tuners are included and available in the content distribution system to receive the usually much larger number of channels that are made available by the content service provider.

In most arrangements, each tuner is statically tuned to a channel based on initial set up by a technician or a person put in charge of controlling the content distribution system, such as the proprietor. The only way for different channels to be tuned is for the technician or proprietor to enter the change by directly connecting to the multichannel receiver device in the system. If a similar level of control over channel changes was provided to each one of the users having devices receiving content from the content distribution system, it is likely that some users would end up inadvertently losing access to program content on a channel as a result of changes made by other users. Apparatuses and mechanisms have been developed that make it easier and more manageable to control channels and limit the effect on users in the distribution system, but these systems still work best when the control is limited to one person, such as the technician or proprietor of the environment or facility. A different solution is to increase the number of signal receivers that are included in the content distribution system. However, implementing such a system amounts to creating a complete local cable or satellite television network that can offer every channel available. Such an implementation would offer little to no cost advantages over simply connecting all of the user devices to the wide area broadcast cable or satellite network that is available. Therefore, a need exists for a mechanism for managing the control of tuners in content distribution to increase the availability of channels to a user without the need to include additional tuners.

### SUMMARY

These and other drawbacks and disadvantages presented by content distribution systems in electronic devices are addressed by the principles of the present disclosure, which are directed to a content distribution device used in a multichannel distribution system. However, it can be understood by those skilled in the art that the present principles may offer advantages in other content distribution systems in other devices as well.

According to an implementation a method is described. The method includes receiving a request from a user device for a program stream over a local network at a receiver device, the request including a join request at a network address, the receiver device containing a set of tuners capable of simultaneously tuning different channels representing program streams that are broadcast from a service provider. The method further includes identifying a channel associated with the network address, the channel being one of a plurality of channels received by the receiver device and determining if the identified channel is already tuned by one of the set of tuners in the receiver device. The method additionally includes tuning the channel using a tuner from the set of tuners that is not currently being used to tune one of the plurality of channels if it is determined that the identified channel is not already tuned and providing the program content from the tuned channel at the network address to the user device over the local network.

According to an implementation, an apparatus is described. The apparatus includes a network communication circuit that receives a request from a user device for a program stream over a local network, the request including a join request at a network address. The apparatus further includes a signal receiving circuit, coupled to the network interface, the signal receiving circuit containing a set of tuners capable of simultaneously tuning different channels representing program streams that are broadcast from a service provider. The signal receiving circuit further identifies a channel associated with the network address, the channel being one of a plurality of channels received by the signal receiving circuit, determines if the identified channel is already tuned by one of the set of tuners, and tunes the channel using a tuner from the set of tuners that is not currently being used to tune one of the plurality of channels if it is determined that the identified channel is not already tuned. The network communication circuit additionally provides the program stream from the tuned channel at the network address to the user device over the local network.

According to an implementation, a system is described. The system includes a user device that initiates a request to join a program stream at a network address over a local network based on a request for the program stream by a user. The system further includes a multichannel content distribution device, coupled to the user device through the local network, the multichannel content distribution device including a set of tuners capable of simultaneously tuning different channels representing program streams that are broadcast from a service provider. The multichannel content distribution device receives the request to join from the user device and identifies a channel associated with the network address, the channel being one of a plurality of channels received by the multichannel content distribution device. The multichannel content distribution device also determines if the identified channel is already tuned by one of the set of tuners and tunes the identified channel using a tuner from the set of tuners that is not currently being used to tune one of the plurality of channels if it is determined that the identified channel is not already tuned. The multichannel content distribution device further provides the program stream from the tuned channel at the network address to the user device over the local network.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a block diagram of a content distribution system to which the principles of the present disclosure are applicable;

FIG. 2 is a block diagram of a multichannel content communication device to which the principles of the present disclosure are applicable;

FIG. 3 is a flow chart of an exemplary process for controlling tuners to which the principles of the present disclosure are applicable; and

FIG. 4 is a flow chart of another exemplary process for controlling tuners to which the principles of the present disclosure are applicable.

### DETAILED DESCRIPTION

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with one or more intermediate components. Such intermediate components may include both hardware and software based components.

The present description illustrates the principles of the present disclosure. It will thus be appreciated that those skilled in the art will be able to devise various arrangements which, although not explicitly described or shown herein, embody the principles of the disclosure and are included within its spirit and scope.

All examples and conditional language recited herein are intended for educational purposes to aid the reader in understanding the principles of the disclosure and the concepts contributed by the inventor to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative system components and/or circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor”, “module” or “controller” should not be construed to refer exclusively to hardware capable of executing software, and may implicitly include, without limitation, a System on a Chip (SoC), digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the embodiments hereof, any element expressed or described, directly or indirectly, as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present embodiments address problems associated with providing additional flexibility for users to have access to more channels of program content in a content distribution system that is confined by the number of tuners available to tune channels in the system. The present disclosure is directed to embodiments for allowing direct control by one or more of the users of the system over some or all of the channel selection in the system as part of receiving program content from the content service provider. The embodiments are particularly useful in systems where the number of channels that can be distributed is less than the number of channels that are made available by the content service provider.

The present disclosure focuses on embodiments that utilize a multichannel content distribution system that receives channels primarily containing program streams or content provided as a live broadcast signal, such as a satellite signal, terrestrial signal, or cable signal. In some embodiments, the multichannel content distribution system may receive program streams or content that may be provided as a quasi-live broadcast signal. Such quasi-live broadcast signals are often delivered as “over the top” (OTT) signals through an internet connection rather than through broadcast signal receiver connection. The aspects of the present disclosure may equally apply to these systems receiving program streams or content as an OTT signal rather than as a live broadcast signal. Further, the multichannel content distribution system may distribute some or all of the received program streams or content to user devices over a first network that is capable of bidirectional communication, such as a local data or IP network. The multichannel content distribution system may additionally distribute some or all of the received program streams or content to the same or different user devices over a second network that is primarily configured to provide one way communication, such as a content rebroadcasting network. In some embodiments, the system may utilize only a single network that is capable of bidirectional communication or may include a second network that is configured to allow two-way communication with limited return path capabilities.

The embodiments take advantage of certain aspects associated with distributing program content in a network that is capable of bidirectional communication. The embodiments utilize the ability of a local IP or data network, such as a local Ethernet network, to transmit information bidirectionally between a local head-end device that receives the program content for distribution and the set of user devices that receive the distributed content over the local network. By utilizing network messages, such as a join message and a leave message, the local head-end device may dynamically reallocate the channel selection for more specific program content delivered to users. Further, the embodiments utilize network addressing schemes to associate a channel that includes the desired program content with a network address in order to facilitate delivery of that program content. The embodiments may further be configured to allow a flexible channel allocation approach. In the flexible allocation approach, some channels may be statically selected, such as for delivery in the content rebroadcasting network while other channels may be selected dynamically and distributed over the local data or IP network. The flexible allocation approach allows any of the channels available from the content service provider to be distributed to a user connected to the multichannel content distribution system.

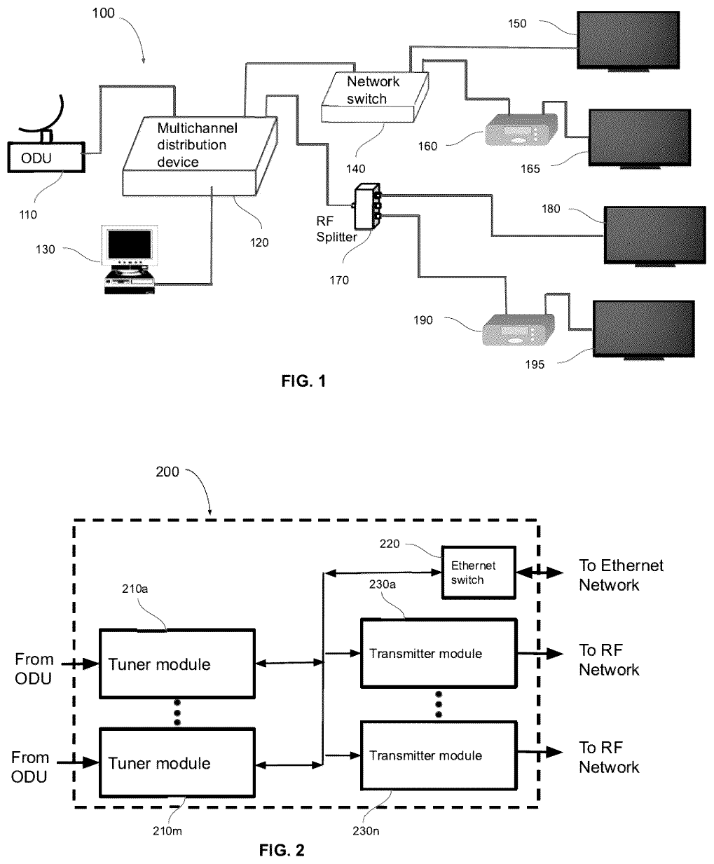

Referring now to FIG. 1, a block diagram of an exemplary embodiment of a content distribution system 100 according to principles of the disclosure is shown. Content distribution system 100 will primarily be described with respect to content delivery over a satellite broadcast communication system. In other embodiments, content distribution systems similar to content distribution system 100 may have content delivered over other types of communication systems including but not limited to microwave broadcast communication systems, cable communication systems, terrestrial broadcast communication systems, internet OTT systems, and the like. Content distribution system 100 allows program content received from a content service provider through the satellite broadcast communication system to be delivered to and/or displayed on multiple devices for multiple users over one or more local networks in an environment or facility. Content distribution system 100 may be commonly found in multi-room facilities such as hotels, apartments, and the like. In addition, content distribution system 100 may also be used in large open room facilities, such as restaurants, sports bars, casinos, and the like.

In content distribution system 100, a signal containing media content from a content service provider from one or more satellites in the sky is provided to outdoor unit (ODU) 110. ODU 110 is coupled to multichannel distribution device 120. Multichannel distribution device 120 is coupled to a computing device 130. Multichannel distribution device 120 is additionally coupled to a first local network that includes network switch 140. Network switch 140 is coupled as part of the first local network to a first set of user devices. The first set of user devices includes television 150 and settop box 160, which is further coupled to television 165. Multichannel distribution device 120 is further coupled to a second local network that includes an RF signal splitter 170. RF signal splitter 170 is coupled as part of the second local network to a second set of user devices. The second set of user devices includes television 180 and settop box 190, which is additionally coupled to television 195. Although content distribution system 100 is shown using two settop boxes and four televisions, in other embodiments additional settop boxes and additional televisions may be used along with additional network switches and RF signal splitters as needed. Further, other user devices, such as computers, display monitors, game consoles may be included in addition to, or in place of, one or more settop boxes and televisions. Further, it is worth noting that although the configuration shows separate sets of user devices connected to each local network, some devices may be connected to both the first local network and the second local network.

ODU 110 converts the satellite broadcast signal delivered from a plurality of satellites from a frequency range associated with satellite communication (e.g., 12 gigahertz (GHz)) to a frequency range that can be transmitted using coaxial cable (e.g., 1 GHz to 2 GHz). The converted satellite broadcast signal contains one or more groups of signal channels or transponders. Each of the signal channels may include one or more program streams containing content (e.g., audio, video, data) organized or grouped using a broadcast transport stream protocol, such the motion picture entertainment group (MPEG) standard MPEG-2 transport stream protocol.

Multichannel distribution device 120 tunes and demodulates a set of the signal channels in the converted satellite broadcast signal to extract the program streams, referred to as program channels, from the signal. Multichannel distribution device 120 further re-packages the program streams or channels into two different types of output signals. The first output signal may be a data or internet protocol (IP) signal that is configured as a series of packets that form an IP data stream. The packets may preferably be user datagram protocol (UDP) packets. The packets contain the content from the program streams that have been reformatted for internet protocol (IP) transport, along with network specific data and control information. The second output signal is an RF signal containing one or more newly generated RF signal channels. Each of the RF signal channels contains one or more of the re-packaged program streams using the same MPEG-2 transport format as originally recovered from the tuned signal channels. Each of the RF signal channels is upconverted to a different carrier frequency preferably in the very high frequency (VHF) and ultra high frequency (UHF) bands. Although the present embodiment describes the program streams using an IP transport stream protocol and an MPEG-2 transport stream protocol, it will be appreciated by those skilled in the art that other transport stream protocols may be used, including but not limited to, digital video broadcast (DVB) transport stream protocols, MPEG-4 transport stream protocol, the association of radio industries and businesses (ARIB) transport stream protocol, token ring transport stream protocol, and point to point (PPP) transport stream protocol.

It is worth noting that multichannel distribution device 120 is capable of simultaneously tuning multiple signal channels or transponders in the received signal. However, the number of signal channels that can be tuned will typically be less than the number of signal channels that are provided and available in the received signal. As a result, the multichannel distribution device 120 is considered as capable of tuning a subset of the total number of signal channels available in the received signal from the content service provider at any one time. Additionally, as described above, a signal channel may contain one or more program streams. Each program stream may be included in and referred to as a program channel, with each program channel identified by a numeric value that is often associated with a program channel guide or listing of program channels. In the case where the signal channel contains only one program stream, the term signal channel, program stream, and program channel all refer to, or identify, the same program content that has been provided in the received broadcast signal.

The first output signal from multichannel distribution device 120, referred to as a data or IP signal, is provided for distribution in a first local network that includes the first set of user devices. The first local network is referred to as a local IP network. The local IP network distributes the signal using a wired medium made up of a series of wires bundled as a cable. Examples of cable that can be used includes, but is not limited to, category (Cat) 4. Cat 5, Cat 5e, Cat 6 and similar cable. Network switch 140 receives the IP signal from content distribution device 120 and distributes the IP signal to other devices in the local IP network, such as television (TV) 150 and settop box 160.

In some embodiments, network switch 140 is configured as a managed Ethernet switch. A managed Ethernet switch allows a technician or proprietor to manage, configure, and monitor the settings of a local network, such the local IP network, including settings to control data traffic, prioritize certain delivery channels or packet types, and create new virtual networks to keep smaller groups of user devices segregated and to better manage their traffic. A managed Ethernet switch also has the ability to monitor and control the network to shut down active threats as well as manage, control and protect the data transmitted by the network. In one embodiment, a managed Ethernet switch used for network switch 140 may be configured to control the specific flow of a type of IP packets called multicast IP packets. For example, all of the program content in multicast IP packets may be sent from content distribution device 120 to network switch 140. Network switch 140 may be configured to only send certain multicast IP packets to either TV 150 or settop box 160 if TV 150 or settop box 160 request program content at a specific multicast IP address via internet group management protocol (IGMP) requests.

The second output signal from multichannel distribution device 120, referred to as an RF signal, is provided for distribution in a second network that includes the second set of user devices. The second local network is referred to as a local RF network. The local RF network distributes the signal using a wired medium referred to as coaxial cable. Examples of coaxial cable that can be used include, but are not limited to, radio guide (RG) 59, and RG 179. RF signal splitter 170 receives the RF signal from content distribution device 120 and distributes the RF signal to other devices in the local RF network, including TV 180 and settop box 190.

TV 150 may include processing circuitry, a display, audio speakers, and a user interface, along with an Ethernet signal interface for connecting to the Ethernet network. TV 150 may be referred to as an IPTV. Settop box 160 may include processing circuitry and a user interface along with a similar Ethernet signal interface as included on TV 150. In addition, settop box 160 may include circuitry to convert the Ethernet signals received from the local IP network into signals capable of being provided to and displayed on TV 165 through a television signal interface. Examples of television interfaces include, but are not limited to, a high definition multimedia interface (HDMI), a digital visual interface (DVI), a video graphics array (VGA) interface, and the like.

TV 180 may include processing circuitry, a display, audio speakers, and a user interface, along with an RF signal interface for connecting to the local RF network. Settop box 190 may include processing circuitry and a user interface along with a similar RF signal interface as included on TV 180. In addition, settop box 190 may include circuitry to convert the RF signals received from the local RF network into signals capable of being provided to and displayed on TV 165 through a television signal interface, similar to those described above. As described above, one or more user devices may be capable of being connected to both the local IP network and the RF local network. For instance, TV 150 may additionally include processing circuitry and an RF signal interface, allowing TV 150 to also be connected to the local RF network. Similarly, settop box 190 may additionally include processing circuitry and an IP signal interface, allowing settop box 190 to also connect to the local IP network.

Computing device 130 is used for setup and management of the operations of multichannel distribution device 110. For instance, computing device 130 may be used by a technician in charge of the operating content distribution system 100 to set up the initial program streams that will be provided over the local IP network and the local RF network. The computing device 130 may also be used to monitor use and performance of the content distribution system 100 as well as troubleshoot issues when they arise. The computer device 130 may be connected directly to multichannel distribution system 110, as shown, through a computer connection, such as Ethernet. The computing device 130 may also be connected to the local IP network at a location remote from the multichannel distribution system. Examples of computing device 130 include, but are not limited to, a desktop computer, a laptop computer, a netbook computer, and a tablet.

The local IP network operates in a distinctly different manner than the local RF network in that the local IP network permits bidirectional communication while the local RF network can only communicate in one direction. The ability of the local IP network to provide information and data from the user devices (e.g., TV 150 and settop box 160) to the multichannel distribution device 120 provides important advantages with respect to the operation of content distribution system 100. One or more aspects of the present disclosure will make use of these advantages in its embodiments.

In operation, a user requests a channel containing a desired program through a user device, such as TV 150 or settop box 160. The user request is converted into a signal that can be communicated on the local IP network. The signal includes a join request for program content at an IP address. The signal containing the join request is received at the multichannel distribution device 120 through the local IP network. The multichannel distribution device 120 processes the join request to identify a channel that is available in the received signal and associated with the IP address in the join request. The multichannel distribution device 120 further determines if the identified channel is a channel that is already tuned and available. The multichannel distribution device 120 tunes the identified channel to recover the desired program content using a tuner that is not currently being used to tune any other channel in the received signal based on the determination. The multichannel distribution device 120 provides the desired program content from the tuned channel at the internet protocol address to the user device (e.g., TV 150 or settop box 160). Additional user requests for program content may be processed in a similar manner.

The multichannel distribution device 120 may keep a list of tuners in use and the signal channels that the tuners are receiving. Tuners that are marked as not in use, even though tuned to a channel are made available for user requests. In some embodiments, in order to manage the use and availability of tuners, the multichannel distribution device 120 may also receive messages indicating that a program stream previously requested by a user is no longer being received by that user. The received message may include a leave request for program content at an IP address based on current activity of the user that made the original request for content. The multichannel distribution device 120 processes the leave request to identify the channel that is associated with the IP address in the leave request. The multichannel distribution device 120 marks the tuner that is tuning the identified channel as unused or available. The multichannel distribution device may, in some cases, verify that no other requests received require program content from the identified channel before marking the tuner as unused or available. The multichannel distribution device 120 may also terminate the delivery of the program content for the identified channel to the Ethernet network. Information regarding the operation of a content distribution system and specifically a multichannel network communication device similar to multichannel distribution device will be described in further detail below.

It is worth noting that one or both of the local data or IP network and local RF network may be distributed to the user devices (e.g., TV 150, settop box 160, TV 180 and settop box 190) as a local wireless signal instead of as a wired signal over a wired medium without deviating from the principles of the present disclosure. Several local wireless communication protocols may be used including, but not limited to, IEEE standard 802.11, Wi-Fi, and the like.

Turning to FIG. 2, a block diagram of an exemplary embodiment of a multichannel content distribution device 200 according to aspects of the present disclosure is shown. Multichannel content distribution device 200 operates in a manner similar to multichannel distribution device 120 described in FIG. 1. Multichannel content distribution device 200 is primarily configured to receive signals from one or more broadcast satellites, process the signals to convert them for delivery over one or both of an Ethernet network containing an IP data signal and an RF network containing a quadrature amplitude modulated (QAM) signal. Other embodiments may be configured to receive and/or provide different types and formats of signals. In multichannel content distribution device 200, the input signal (e.g., converted satellite broadcast signal in FIG. 1) is coupled to each of the tuner modules 210a-m. The input signal is provided, either directly or indirectly through one or more RF signal splitters (not shown), from an outdoor signal receiving unit, such as ODU 110. All of the tuner modules 210a-m are coupled to all of the transmitter modules 230a-n as well as to the Ethernet switch 220 using a high speed data communication bus, such as gigabit Ethernet. One or more of the connections on Ethernet switch 220 also provides an Ethernet or IP data signal to a local Ethernet network that operates in a manner similar to the local IP or data network described in FIG. 1. Additionally, an RF signal is provided from the outputs of transmitter modules 230a-n, either directly or indirectly through one or more RF signal combiners or diplexers (not shown), to the RF network. It is worth noting that multichannel content distribution device 200 is configurable to include as little as a single tuner module and/or a single transmitter module or as many as m tuner modules and/or n transmitter modules depending on requirements for the system and the cost incurred. It is to be appreciated that several components and interconnections necessary for complete operation of multichannel content distribution device 200 are not shown in the interest of conciseness, as the components not shown are well known to those skilled in the art.

Tuner modules 210a-m tune and demodulate one or more signal channels or transponders in the satellite signal and produce an MPEG-2 transport stream that includes one or more program streams or program channels. The satellite signal is received at each of the tuner modules 210a-m through one or more suitable RF connectors, such as F-type connectors, mounted on the multichannel content distribution device 200. One or more external RF signal splitters (not shown) similar to RF signal splitter 170 in FIG. 1 may be used to divide the satellite signal to provide separate satellite signals to each of the tuner modules 210a-m. Each one of the individual tuning and demodulating functions used in modules 210a-m may be included in one or more components, such as integrated circuits or multi-chip modules, referred to as a tuner. The components used in the tuners are the same as those commonly used in other consumer or commercial broadcast satellite communication systems. The components used in the tuners may include, but are not limited to, L-band downconverters, analog to digital signal converter 4-phase and 8-phase shift keyed demodulators, error correction decoders, and the like. It is worth noting that each one or the tuner modules 210a-m produces a separate MPEG-2 transport stream. In order to facilitate the transfer of the program streams to other components in multichannel content distribution device 200, each of the tuner modules 210a-m further rearranges or reconstructs the MPEG-2 transport streams to create internet protocol streams that are arranged in UDP packets containing data, audio and video programming. The internet protocol streams are provided to the high speed data communication bus for distribution to other components in multichannel content distribution device 200. The conversion between the transport stream for the received signal (e.g., the MPEG-2 transport stream) and the transport stream used for distributing the signal over the first network is necessary because the packet structure of UDP packets in an IP transport stream is very different from the packet structure in the MPEG-2 transport stream.

It is worth noting that in some embodiments, each of the tuner modules 210a-m includes only one tuner capable of tuning one channel, although embodiments having more tuners are possible. In a preferred embodiment, each of the tuner modules 210a-m includes tuning and demodulation circuits, or tuners, for receiving and tuning between and 8 and 23 satellite transponders simultaneously, depending on customer configuration. The total number of satellite transponders that may be tuned simultaneously further depends on the number of tuner modules included in the configuration of multichannel content distribution device 200. While the present embodiment utilizes tuners capable of receiving satellite broadcast signals and MPEG-2 transport streams, it will be appreciated by those skilled in the art that other kinds of tuners are equally usable, and many different types of transport protocols are also usable. Therefore, over the air broadcast tuners, microwave broadcast tuners, broadcast tuners, and their equivalents are all covered by the present disclosure. Moreover, other signaling transport streams, as described above, and their equivalents are also covered by the disclosure.

Each of the tuner modules 210a-m may also include a processor and memory for performing calculations as well as controlling the operations of the tuner modules 210a-m. The processor may be a programmable microprocessor that is reconfigurable with downloadable instructions or software code stored in the memory. The processor may alternatively be a specifically programmed controller and data processor with internal control code for controlling, managing, and processing all functions and data in the tune modules 210a-m. The memory supports the content and data processing as well as IP functions in the processor and also serves as storage for applications, programs, control code and media content and data information. The memory may include one or more of the following storage elements including, but not limited to, RAM, ROM, Electrically-Erasable Programmable ROM (EEPROM), and flash memory. The memory may also encompass one or more integrated memory elements including, but not limited to, magnetic media hard disk drives and optical media disk drives. Digital content and/or data stored in the memory may be retrieved by the processor, processed, and provided either to other elements of the tuner modules 210a-m or onto the high speed communication bus in multichannel content distribution device 200.

Ethernet switch 220 may be configured as a managed or smart Ethernet switch as described above in FIG. 1. Ethernet switch 220 manages and controls the delivery of the internet streams that are provided over the high speed data communication bus for distribution to external devices (e.g., TV 150 and settop box 160 in FIG. 1) over a first network (e.g., the local IP network described in FIG. 1). Preferably, the high speed data communication bus is compliant with the Ethernet, IEEE 802.3, or similar communication protocol. Ethernet switch 220 includes one or more type RJ-45 physical interface connectors or other standard interface connectors to allow connection to an external local computer used for setting up operation of the multichannel content distribution device 200 as well as the local ethernet network.

The transmitter modules 230a-m receive the internet protocol streams from the high speed data communication bus and reformat the internet protocol streams into MPEG-2 transport streams for delivery as a broadcast cable signal. Each of the transmitter modules 230a-m modulates and upconverts one or more of the MPEG-2 transport streams to produce one or more output channels. The functions and components may include, but are not limited to, error correction encoders, multi-level quadrature amplitude modulation signal modulators, digital to analog signal converters, VHF and UHF upconverter, and the like. The one or more output channels are configured to be frequency diverse allowing RF circuits (e.g., splitters, filters, diplexers, amplifiers) to be used to combine each of the one or more output channels and deliver the aggregation of all output channels on a single cable through an interface connector, such as a F-type connector, on the multichannel content distribution device 200. In one embodiment, each of the transmitter modules 230a-n transmits QAM modulated channels on one of 16 carrier frequencies simultaneously, depending on customer configuration. The total number QAM modulated channels that may be transmitted simultaneously further depends on the number of transmitter modules included in the configuration of multichannel content distribution device 200. While the present embodiment utilizes QAM modulators and MPEG-2 transport streams, it will be appreciated by those skilled in the art that other kinds of modulators are equally usable, and many different types of transport protocols are also usable. Therefore, vestigial sideband (VSB) modulators, quadrature phase shift keying (QPSK) modulators, orthogonal frequency division multiplexing (OFDM) modulators, and their equivalents are all covered by the present disclosure. Moreover, other signaling transport streams, as described above, and their equivalents are also covered by the present disclosure.

Each of the transmitter modules 230a-n may also include a processor and memory for performing calculations as well as controlling the operations of the transmitter modules 230a-n. The processor may be a programmable and/or configurable microprocessor or may be a specifically programmed controller and data processor, as described above, for controlling, managing, and processing all functions and data in the transmitter modules 230a-n. The memory supports the content and data processing as well as IP functions in the processor and also serves as storage for applications, programs, control code and media content and data information. The memory may include one or more of the elements described above. Digital content and/or data stored in the memory may be retrieved by the processor, processed, and provided either to other elements of the transmitter modules 230a-n or onto the high speed communication bus in multichannel content distribution device 200.

The operational settings for each of the tuner modules 210a-m and transmitter modules 230a-n may be initialized and updated using an external device, such as computing device 130 in FIG. 1. The processor in each of the tuner modules 210a-m and transmitter modules may receive one or more commands through Ethernet switch 220 from an application interface on the external device based on entries made by a technician or proprietor of the content distribution system (e.g., content distribution system 100 in FIG. 1). For instance, using the application interface, a set of commands may be provided to tune each of the tuners in the tuner modules 210a-m to a predetermined set of signal channels available in the received signal. A set of commands may also be provided to transmitter modules 230a-n to modulate a predetermined set of program streams from the tuned set of signal channels onto channels at a set of frequencies transmitted. The set of commands may further be provided to the transmitter modules 230a-n to transmit an output signal containing the modulated channels on the local RF network. Other commands may be provided to control other aspects of operation depending on the application.

Commands or requests may also be provided to the processors in tuner modules 210a-m for changing one of the tuners to a signal channel based on input received from users through user devices (e.g., TV 150 and settop box 160 in FIG. 1) on the local Ethernet network. For instance, a request may be received to join an IP stream of program content to an IP address. The processors in tuner modules 210a-m service the request by identifying a signal or program channel associated with the IP address and determining if the identified signal or program channel is already one of the channels tuned by the tuner modules 210a-m. As described above, in some instances the program channel is the same as the signal channel. In other instances, the program channel is a part of the signal channel where the signal channel includes more than one program channel or program stream. If the signal or program channel is not already tuned, the processors identify a tuner that is available for use and tunes the available tuner to the identified signal or program channel. One of the tuner modules 210a-m provides the program stream or content from the signal or program channel in a proper format to the high speed data communication bus. The ethernet switch 220 provides the program content as an IP data stream at the requested IP address over the local Ethernet network to the user device that made the request. Additionally, in some embodiments, a request may be received to leave an IP stream of program content at an IP address, effectively ending the IP stream. The processors in the tuner modules 210a-m service this request by identifying the signal or program channel associated with the IP address and determining if the identified signal or program channel is in use for any other purpose, such as program a different program stream from the same signal channel. The processors may deallocate the tuner that is tuned to the identified signal or program channel if the identified channel is not in use for any other purpose.

In some embodiments, all of the tuners in tuner modules 210a-m may be dynamically tuned or allocated for servicing requests for program content from user devices. However, allowing all of the tuners to dynamically tune may prevent some users from having program content or channel requests from being fulfilled, particularly for users with user devices using the signal on the local RF network. In some embodiments, a hybrid approach may be implemented. In the hybrid approach a subset of the tuners are tuned to a fixed set of channels (e.g., by a technician or proprietor) as part of the set-up of the multi-channel content distribution device 200. The set of channels that are statically tuned may be determined based on any number of criteria including, but not limited to, most viewed channels over a recent time period, cost of licensing the program content on the channels, demographics of the users, and the like. This subset of tuners remains statically tuned to the set of channels unless later changed as part of an additional set-up of the multichannel content distribution device 200. The remaining tuners are available for servicing requests, such as join requests or leave requests as described above.

Although the tuner modules 210a-m and transmitter modules 230a-n are described as each having a processor and memory and each receiving requests and commands, alternate arrangements may also be used. In some embodiments only one of the tuner modules 210a-m and one of the transmitter modules 230a-n include a processor and memory. In other embodiments, one of the processors in the tuner modules 210a-m and one of the processors 230a-n is identified as the master processor. The master processor may be identified during manufacturing or during initial set-up (e.g., by a technician or proprietor) of the multichannel content distribution device 200. The user of a master processor may simplify communication with and between the tuner modules 210a-m as well as the transmitter modules 230a-n. For instance, any request (e.g., IGMP join request or IGMP leave request) is provided only to the master processor in the one of the tuner modules 210a-m. The master processor coordinates settings and operations between all of the tuner modules 210a-m and also coordinates servicing the request.

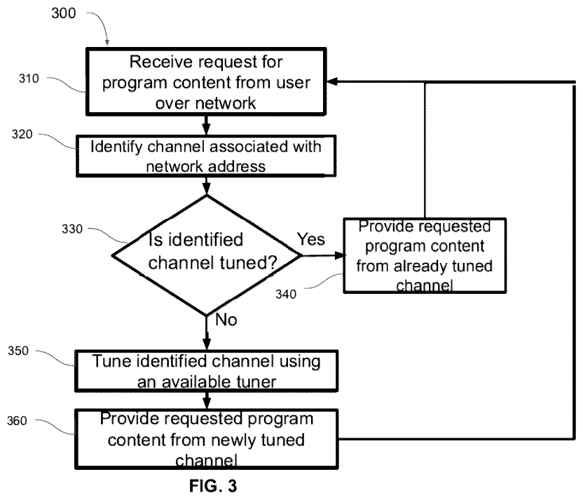

Turning to FIG. 3, a flow chart of an exemplary process 300 for controlling tuners in a signal receiver device according to aspects of the present disclosure is shown. The receiver device may be included as part of signal redistribution device capable of receiving signals and redistributing those signals in a local network, such as multichannel content distribution device 200 described in FIG. 2. As such, the process 300 will be primarily described with respect to the multichannel content distribution device 200. One or more aspects of process 300 may also be performed by a receiver device as part of a content distribution system, such as content distribution system 100 described in FIG. 1. Although process 300 depicts steps performed in a particular order for purposes of illustration and discussion, the operations discussed herein are not limited to any particular order or arrangement. Further, while process 300 is described in association with a satellite broadcast content distribution system, process 300 may easily be adapted for use in other content distribution systems, such as a cable broadcast content distribution and the like. One skilled in the art, using the disclosure provided herein, will also appreciate that one or more of the steps of process 300 may be omitted, rearranged, combined, and/or adapted in various ways.

At step 310, a request is received for program content at the local network interface (e.g., network switch 220) of the receiver device (e.g., multichannel content distribution device 200) over a local data network (e.g., local Ethernet network described in FIG. 2) used for distributing program streams from the receiver device. The request may be made by a user changing control settings through a user interface on a user device (e.g., TV 150 or settop box 160 described in FIG. 1). The user request is converted to a network message (e.g., an IP message). The network message includes a network address (e.g., an IP address) that is associated with a channel received by the receiver device. The associated channel contains the requested program content. The network address is provided from the user device over a network (e.g., the local ethernet network described in FIG. 1). In some embodiments, the user request is translated into an IGMP message by the user device. The IGMP message is a join request generated by the user device (e.g. TV 150). The IGMP request is transmitted onto the local data network. The IGMP request is ordinarily intended for an Ethernet switch in the local data network (e.g. Network switch 140 in FIG. 1) to begin forwarding multicast packets on the particular network IP address associated with the program content to the user device. The IGMP request may not ordinarily be rebroadcast to other devices in the network, however, in some embodiments, the Ethernet switch in the local data network is advantageously configured to route the IGMP request to all other user devices on the local network, including the receiver device.

When the receiver device receives the IGMP join request, the receiver device may determine the type of request based on a portion of the IP address in the join request. For instance, the first two octets of the IP address may be a value, such as 226.101, that is within the IP address range associated with requests for requests from users that initiate dynamic tuning of one of the tuners. Any IP addresses that have values for the first two octets outside the range may be for other requests, such as to initiate a change to one of the tuners that are statically tuned.

At step 320, the channel containing the program content requested by the user, at step 310, is identified in the receiver device (e.g., multichannel content distribution device 200). As described above, the channel is associated with the network address that is included in the network message sent to the receiver device. In order to facilitate the identification, the received request may be further distributed internally to the receiver device (e.g., Ethernet switch 220) over a data bus (e.g., the high speed data communication bus) to each one of the tuners (e.g., tuner modules 210a-m) in order for each to tuner to perform a separate identification as well as further evaluation. In some embodiments, the identification, at step 320 includes converting the network address to the identification number used for the channel. For instance, the channel number may be a portion of the network address. The channel number may further be encoded into the host portion of the IP address. In some embodiments that use an IP address for the network address, the channel number is determined by multiplying the third octet of the IP address by 100 and adding the result to the fourth octet of the IP address.

It is worth noting that a user device (e.g., TV 150 or settop box 160 described in FIG. 1) will need to initially generate or otherwise know the relationship between the request from the user, such as a request for a channel number, and the values that need to be included in the IP address for the IGMP request. In some cases, the user device (e.g., settop box 160) may be supplied to the user by the same manufacturer for the received device (e.g., multichannel content distribution device 120). The user device may implement the same identification algorithm as used by the receiver device but in reverse. For instance, the third and fourth octets of the IP address may be determined by integer dividing the requested channel number by 100 to produce the third octet and using the remainder or modulus value for the fourth octet. In other cases, such as when the user device is not supplied, (e.g., TV 150) as a data table that maps channel numbers to IP addresses may be downloaded into the user device using a local connection for a computer or memory device.

At step 330, a determination is made as to whether the channel identified, at step 320, is already tuned by one of the tuners (e.g., tuner modules 210a-m) in the receiver device (e.g., multichannel content distribution device 200). In some cases, the identified channel may represent a program channel that is included as part of a signal channel that is already tuned and providing a program stream or program channel to other users in one of the local networks. In other cases, the identified channel may be one, or a part of one, of the signal channels that is statically tuned, such as in a hybrid content delivery system, as described above.

If, at step 330, it is determined that the identified channel is already tuned, then, at step 340, the receiver device (e.g., multichannel content distribution device 200) may only need to configure the ethernet switch (either ethernet switch 220 or network switch 140 described in FIG. 1) to broadcast the program stream for the identified requested by the user to the multicast IP address over the local data network (e.g., local Ethernet network described in FIG. 2). In some embodiments, the receiver device may configure the tuner that is currently tuning the signal channel containing the identified channel program content to change parameters in the demodulation function to decode the program content for the identified channel. The tuner or other circuitry in the receiver device may further convert the MPEG-2 transport stream from the demodulation function into a suitable IP transport stream containing packets at the particular multicast IP address to fulfill the user request.

If, at step 330, it is determined that the identified channel is not already tuned, then, at step 350, the receiver device (e.g., multichannel content distribution device 200) configures a tuner that is marked as not currently in use, or is currently available, to tune to the channel in the signal received by multichannel content distribution system that was identified, at step 320. In some embodiments, the receiver device may generate a list of current status of each of the tuners (e.g., tuner modules 210a-m), as described above. In some embodiments, each tuner may have a status flag that can be read by the receiver device. The receiver device may further configure the tuner that is newly tuned to the identified channel to decode the data packets from the tuned signal before combining the packets into an existing MPEG-2 transport stream.

At step 360, the receiver device (e.g., multichannel content distribution device 200) provides the program stream or content requested by the user from the tuner (i.e., a tuner in tuner modules 210a-m) that is now tuned to the identified channel, at step 350, at the network address over the local data network (e.g., local Ethernet network described in FIG. 2). The tuner or other circuitry in the receiver device may further convert the MPEG-2 transport stream into a suitable IP transport stream containing packets at the particular IP address to fulfill the user request.

After providing the requested program content to the user from the identified channel that is already tuned, at 340, or providing the requested program content to the user from the identified channel that is newly tuned, at step 360, process 300 returns to wait to receive another request from a user for program content, at step 310.

In some embodiments, the request may be specifically provided (e.g., by Ethernet switch 220 over the high speed data communication bus) to only one of the tuners (e.g., one of the tuner modules 210a-m). Once the master tuner identifies the channel associated with the network address, the master tuner may communicate this information with the remainder of the tuners 210a-m. The master tuner may further manage all communication between the other tuners as well as communication with other elements in the receiver device (e.g., multichannel content distribution device 200) in a manner similar to that described above.

It is worth noting that, as described above, the number tuners (e.g., tuner modules 220a-m) in the receiver device (e.g., multichannel content distribution device 200) may be less than the number of channels available in the received signal, such as the satellite broadcast signal delivered by a content service provider. As a result, it is possible that a request for program content made by a user may not be able to be immediately fulfilled. In some embodiments, the receiver device (e.g., multichannel content distribution device 200), after determining that no tuners are available to tune the identified channel, at step 350, may generate a message that the request cannot be fulfilled at this time. The message may be provided over the local network and displayed to the user on a display device (e.g., TV 165 connected to settop box described in FIG. 1).

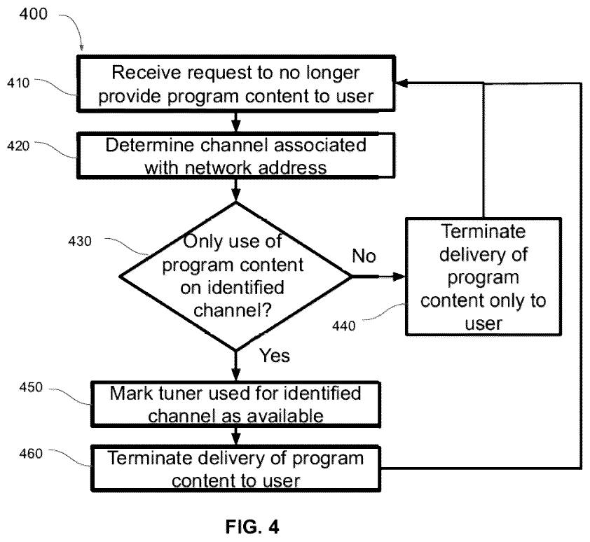

Turning to FIG. 4, a flow chart of an exemplary process 400 for controlling tuners in a multichannel content distribution system according to aspects of the present disclosure is shown. Process 400 is primarily described with respect to a content distribution device, such as multichannel content distribution device 200 described in FIG. 2. Process 400 may also be performed by a device as part of a content distribution system, such as content distribution system 100 described in FIG. 1. Although process 400 depicts steps performed in a particular order for purposes of illustration and discussion, the operations discussed herein are not limited to any particular order or arrangement. Further, while process 400 is described in association with a satellite broadcast content distribution system, process 400 may easily be adapted for use in other content distribution systems, such as a cable broadcast content distribution and the like. One skilled in the art, using the disclosure provided herein, will also appreciate that one or more of the steps of process 400 may be omitted, rearranged, combined, and/or adapted in various ways.

It is worth noting that although process 300 described in FIG. 3 and process 400 described in FIG. 4 are described as separate processes, one or more steps or aspects of process 300 and process 400 may be combined. In some embodiments, the need for aspects from both process 300 and process 400 may be required or necessary for controlling tuners in a receiver device, such as multichannel content distribution device 200, when used in a content distribution system (e.g., content distribution system 100).

At step 410, a request is received at the local network interface (e.g., network switch 220) of the receiver device (e.g., multichannel content distribution device 200) over a local data network (e.g., local Ethernet network described in FIG. 2) used for distributing program streams from the receiver device. The request indicates that program content is no longer to be provided or forwarded at a network address to a user device (e.g., TV 150 or settop box 160 described in FIG. 1). The request may be generated by the user device based the user changing control settings through a user interface on a user device. The user request is converted to a network message (e.g., an IP message). The network message includes a network address (e.g., an IP multicast address) that is associated with a channel that is currently tuned by the receiver device. The associated channel contains the program content that is no longer desired. The network address is provided from the user device over the local data network. In some embodiments, the user request is translated into an IGMP message by the user device. The IGMP leave message is a leave request generated by the user device to terminate the forwarding packets on the particular network IP address associated with the program content to the user device. The IGMP request is transmitted over the local data network. Once the IGMP request reaches an Ethernet switch (e.g., network switch 140 described in FIG. 1) in local network, after some evaluation, the Ethernet switch may forward the IGMP leave request to the receiver device.

At step 420, the channel associated with the network address in the received request, at step 410, is identified in the receiver device (e.g., multichannel content distribution device 200). As described above, the channel is associated with the network address that is included in the network message sent to the receiver device. In order to facilitate the identification, the received request may be further distributed internally to the receiver device (e.g., Ethernet switch 220) over a data bus (e.g., the high speed data communication bus) to each one of the tuners (e.g., tuner modules 210a-m) in order for each to tuner to perform a separate identification as well as further evaluation. In some embodiments, the identification, at step 420 includes converting or decoding the channel number from the network address as described above.

At step 430, a determination is made in the receiver device (e.g., multichannel content distribution device 200) as to whether the received request, at step 410, is the only use for the program content from the channel identified, at step 420. In some cases, the identified channel may represent a program channel that is included as part of a signal channel that is additionally providing a program stream or program channel to other users in one of the local networks. In other cases, the identified channel may be one, or a part of one, of the signal channels that is statically tuned, such as in a hybrid content delivery system, as described above.

If, at step 430, it is determined that the request is not the only use of the program content then, at step 440, the receiver device (e.g., multichannel content distribution device 200) terminates or ceases the delivery of the program content for the identified channel over the network (e.g., local ethernet network) to only the user device that sent the request to no longer provide program content. The receiver device maintains tuning of the signal channel when the identified channel is a program channel in order to continue providing program content from one or more of the other program channels that are part of the signal channel to other user devices over the network. In some embodiments. The receiver device may configure the tuner that is currently tuning the signal channel containing the identified channel to change parameters in the demodulation function to stop decoding the program content for the identified channel.

If, at step 430, it is determined that the request is the only use of the program content then at step 450, the receiver device (e.g., multichannel content distribution device 200) identifies or marks the tuner that is currently tuned to the identified channel as currently available or not in use. In some embodiments, the receiver device may generate a list of current status of each of the tuners (e.g., tuner modules 210a-m) or each of tuners (e.g., tuner modules 210a-m) may have a settable status flag, as described above.

At step 460, the receiver device (e.g., multichannel content distribution device 200) terminates delivery of program content from the identified channel, at step 450, to the user device at the network address over the local data network (e.g., local Ethernet network described in FIG. 2). After terminating delivery of program content for the identified channel, at step 440, or marking the tuner tuned to the identified channel as available, at step 460, process 400 returns to wait to receive another request to no longer provide program content, at step 410.

It is worth noting that the request received, at step 410, may not be explicitly generated by a user. In some embodiments, the user device may be configured to only receive and process one program stream at a time. As a result, when a new request is received for different program content (e.g., at step 310 in FIG. 3) the receiver device (e.g., multichannel content distribution device 200) may initiate processing to terminate delivery of the program stream at the previously identified channel to the user device and mark the tuner as available before processing the new request.

In some embodiments, the Ethernet switch (e.g., Ethernet switch 220) in the receiver device (e.g., multichannel content distribution device 200) may be configured as a controller and transmit IGMP query packets over the local data network. IGMP query packets contain commands that cause any device that has previously sent an IGMP join request to retransmit all active IGMP join requests that have been made. The Ethernet switch in the receiver device can use responses or lack of responses to end or cause to timeout any IGMP join requests. For instance, a previous IGMP join request from a user device can be ended if multiple IGMP query commands are transmitted without receiving the re-transmitted IGMP join command from the user device. Such a situation may occur if power to the user device (e.g., TV 150 or settop 160 in FIG. 1) is unexpectedly removed. Ending an IGMP join request in this manner may initiate processing to terminate delivery of the program stream as described above.

In some embodiments, timeout of keep alive counters may be maintained for each tuner that can be allocated for dynamically tuning channels based on user requests for program content. The counter is decremented each time an IGMP query command, such as described above, is transmitted over the local ethernet network and also communicated internally in the receiver device (e.g., multichannel content distribution device 200). In some cases, a keep alive counter may also be implemented based on receiving IGMP join requests.

In some embodiments, particularly in embodiments where the availability of tuners for dynamic tuning is limited compared to the possible number of requests from users, timeout counters may be used as part of managing the delivery or termination of program streams. For example, termination of a program stream may be based on the number of tuners still available and identification, based on counters for the tuners, of the tuner with the longest time since the last time it was tuned. Such a situation may occur if the user properly turns off a user device, but the user device turns off in a mode where the program content is still being delivered to the user device.

In some embodiments, the request may be specifically provided (e.g., by Ethernet switch 220 over the high speed data communication bus) to only one of the tuners (e.g., one of the tuner modules 210a-m) that has been identified as the master tuner as described above. Once the master tuner identifies the channel associated with the network address, the master tuner may communicate this information with the other tuners in the receiver device. The master tuner may further manage all communication between the other tuners as well as communication with other elements in the receiver device (e.g., multichannel content distribution device 200) in a manner similar to that described above.

As described above, one or more aspects of process 300 may be combined with one or more aspects of process 400 to provide a mechanism for controlling tuners used for delivering program content in a multichannel distribution system, such as described in FIG. 1. As a specific example, settop box 160 may be requested by a user to tune or access program content for a channel identified as channel 360. Settop box 160 determines that channel 360 should be made available on multicast IP address 226.101.3.60, based on the encoding method used for associating channels received by the multichannel distribution device 120 and IP addresses. Settop box 160 sends an IGMP join request data packet to network switch 140 over the local data or IP network. The IGMP request to join instructs the network switch 140 to forward multicast packets containing the program content for channel 360 on multicast IP address 226.101.3.60 to settop box 160. The Ethernet Switch 140 forwards the IGMP join request to all other devices on the local data or IP network including the multichannel distribution device 120.

The multichannel distribution device 120 receives the IGMP request to join that was forwarded by network switch 140. The multichannel distribution device 120 also determines that request to join includes an IP address that starts with 226.101, indicating the request is associated with multicast IP packets as part of dynamic tuning. The multichannel distribution device 120 identifies a channel that includes the requested program content based on the host portion of the IP address, as described above. The multichannel distribution device 120 determines if any of the tuners currently in use are currently tuned to channel 360 and providing program content to IP address 226.101.3.60. If none of the tuners are currently tuned to channel 360 and providing program content to IP address 226.101.3.60, the multichannel distribution device 120 identifies a tuner that is currently not in use for providing program content and configures the identified tuner to tune channel 360. The multichannel distribution device 120 also configures tuner to provide the requested program content as multicast packets on IP address 226.101.3.60 to the local data or IP network. The network switch 140 receives the multicast packets on IP address 226.101.3.60 and forwards the packets to settop box 160 for display as video and audio on TV 165.

At a later point in time, the user requests that settop box 160 tune away (e.g. to a different channel) from channel 360. Settop box 160 sends an IGMP Leave message for 226.101.3.60 to the network switch 140 to indicate that packets should no longer be forwarded from the specified multicast address. The network switch 140 will forward the IGMP Leave message over the local data or IP network to the multichannel distribution device 120.

The multichannel distribution device 120 receives the IGMP leave message and determines that request to leave includes an IP address that starts with 226.101, indicating the request is associated with multicast IP packets as part of dynamic tuning. The multichannel distribution device 120 identifies a channel that includes the requested program content based on the host portion of the IP address, as described above. The multichannel distribution device 120 identifies the tuner used for tuning channel 360. If the multichannel distribution device 120 determines that no other devices are receiving the multicast address, the multichannel distribution device 120 terminates delivery of the program content on IP address 226.101.3.60. The multichannel distribution device 120 also deallocates the tuner used for tuning channel 360, making it available for use to tune a different channel based on another user request for program content.

According to the present disclosure, a method is described that includes receiving a request from a user device for a program stream over a local network at a receiver device, the request including a join request at a network address, the receiver device containing a set of tuners capable of simultaneously tuning different channels representing program streams that are broadcast from a service provider. The method also includes identifying a channel associated with the network address, the channel being one of a plurality of channels received by the receiver device and determining if the identified channel is already tuned by one of the set of tuners in the receiver device. The method further includes tuning the channel using a tuner from the set of tuners that is not currently being used to tune one of the plurality of channels if it is determined that the identified channel is not already tuned and providing the program stream from the tuned channel at the network address to the user device over the local network.

In some embodiments, the method may further includes receiving a request associated with the user device, the request including a leave request for a previously requested program stream at a network address, identifying the channel associated with the network address, and deallocating the tuner used to tune the identified channel.

In some embodiments, the method may further include determining if the previously requested program stream is being delivered to another user device before deallocating the tuner.

In some embodiments, the method may further include terminating the delivery of the program content from the identified channel over the local network if no other user devices have requested the program stream.

In some embodiments, wherein the receiver device may further includes a subset of the tuners that are always tuned to a fixed set of the plurality of channels.

In some embodiments, the number of the plurality of channels may be greater than the number of the set of tuners in the receiver device.

In some embodiments, the receiver device may be included as part of a multichannel content distribution device.

According to the present disclosure, an apparatus is described that includes a network communication circuit that receives a request from a user device for a program stream over a local network, the request including a join request at a network address. The apparatus further includes a signal receiving circuit, coupled to the network communication circuit, the signal receiving circuit containing a set of tuners capable of simultaneously tuning different channels representing program streams that are broadcast from a service provider. The signal receiving circuit further identifying a channel associated with the network address, the channel being one of a plurality of channels received by the signal receiving circuit, determining if the identified channel is already tuned by one of the set of tuners, and tuning the channel using a tuner from the set of tuners that is not currently being used to tune one of the plurality of channels if it is determined that the identified channel is not already tuned. The network communication circuit further provides the program stream from the tuned channel at the network address to the user device over the local network.

In some embodiments, the network communication circuit may further receive a request associated with the user device, the request including a leave request for a previously requested program stream at a network address and the signal receiving circuit may further identifies the channel associated with the network address and deallocates the tuner used to tune the identified channel.

In some embodiments, the signal receiving circuit may further determine if the previously requested program stream is being delivered to another user device before deallocating the tuner.

In some embodiments, the signal receiving circuit may further terminate the delivery of the program stream from the identified channel over the local network if no other user devices have requested the program stream.

According to the present disclosure, a system is described that includes a user device that initiates a request to join a program stream at a network address over a local network based on a request for the program stream by a user. The system further includes a multichannel content distribution device, coupled to the user device through the local network, the multichannel content distribution device including a set of tuners capable of simultaneously tuning different channels representing program streams that are broadcast from a service provider. The multichannel content distribution device further receives the request to join from the user device and identifies a channel associated with the network address, the channel being one of a plurality of channels received by the multichannel content distribution device. The multichannel content distribution device further determines if the identified channel is already tuned by one of the set of tuners, tunes the identified channel using a tuner from the set of tuners that is not currently being used to tune one of the plurality of channels if it is determined that the identified channel is not already tuned, and provides the program stream from the tuned channel at the network address to the user device over the local network.

In some embodiments, identifying the channel may further include converting the network address to a channel number.

In some embodiments, the network address may be an internet protocol address and the channel number may be encoded in a portion of the internet protocol address.

In some embodiments, the channel number may be determined from the internet protocol address by multiplying a third octet of the internet protocol address by 100 and adding the result to a fourth octet of the network protocol address.

In some embodiments, the identified channel may be included in a signal channel tuned by the receiver device, the signal channel including more than one channel with each channel containing a separate program stream.

It is to be appreciated that, except where explicitly indicated in the description above, the various features shown and described are interchangeable, that is, a feature shown in one embodiment may be incorporated into another embodiment.

Although embodiments which incorporate the teachings of the present disclosure have been shown and described in detail herein, those skilled in the art can readily devise many other varied embodiments that still incorporate these teachings. Having described preferred embodiments of a method and apparatus for controlling tuners in a multichannel content distribution system, it is noted that modifications and variations can be made by persons skilled in the art in light of the above teachings. It is therefore to be understood that changes may be made in the particular embodiments of the disclosure which are within the scope of the disclosure as outlined by the appended claims.

1. A method, comprising:
receiving a request from a user device for a program stream over a local network at a receiver device, the request including a join request at a network address, the receiver device containing a set of tuners capable of simultaneously tuning different channels representing program streams that are broadcast from a service provider;
identifying a channel associated with the network address, the channel being one of a plurality of channels received by the receiver device;
determining if the identified channel is already tuned by one of the set of tuners in the receiver device;
tuning the channel using a tuner from the set of tuners that is not currently being used to tune one of the plurality of channels if it is determined that the identified channel is not already tuned; and
providing the program stream from the tuned channel at the network address to the user device over the local network.

2. The method of claim 1, further comprising:
receiving a request associated with the user device, the request including a leave request for a previously requested program stream at a network address;
identifying the channel associated with the network address; and
deallocating the tuner used to tune the identified channel.

3. The method of claim 2, further comprising determining if the previously requested program stream is being delivered to another user device before deallocating the tuner.

4. The method of claim 2, further comprising terminating the delivery of the program content from the identified channel over the local network if no other user devices have requested the program stream.

5. The method of claim 1, wherein the receiver device further includes a subset of the tuners that are always tuned to a fixed set of the plurality of channels.

6. The method of claim 1, wherein a number of the plurality of channels is greater than a number of the set of tuners in the receiver device.

7. The method of claim 1, wherein identifying the channel includes converting the network address to a channel number.

8. The method of claim 7, wherein the network address is an internet protocol address and wherein the channel number is encoded in a portion of the internet protocol address.

9. The method of claim 8, wherein the channel number is determined from the internet protocol address by multiplying a third octet of the internet protocol address by 100 and adding the result to a fourth octet of the network protocol address.

10. The method of claim 1, wherein the identified channel is included in a signal channel tuned by the receiver device, the signal channel including more than one channel with each channel containing a separate program stream.

11. The method of claim 1, wherein the receiver device is included as part of a multichannel content distribution device.

12. An apparatus comprising;
a network communication circuit that receives a request from a user device for a program stream over a local network, the request including a join request at a network address; and
a signal receiving circuit coupled to the network communication circuit (220), the signal receiving circuit containing a set of tuners capable of simultaneously tuning different channels representing program streams that are broadcast from a service provider, the signal receiving circuit further identifying a channel associated with the network address, the channel being one of a plurality of channels received by the signal receiving circuit, determining if the identified channel is already tuned by one of the set of tuners, and tuning the channel using a tuner from the set of tuners that is not currently being used to tune one of the plurality of channels if it is determined that the identified channel is not already tuned;
wherein the network communication circuit further provides the program stream from the tuned channel at the network address to the user device over the local network.

13. The apparatus of claim 12, wherein the network communication circuit further receives a request associated with the user device, the request including a leave request for a previously requested program stream at a network address and wherein the signal receiving circuit identifies the channel associated with the network address and deallocates the tuner used to tune the identified channel.

14. The apparatus of claim 13, wherein the signal receiving circuit further determines if the previously requested program stream is being delivered to another user device before deallocating the tuner.

15. The apparatus of claim 13, wherein the signal receiving circuit further terminates the delivery of the program stream from the identified channel over the local network if no other user devices have requested the program stream.

16. The apparatus of claim 11, wherein identifying the channel includes converting the network address to a channel number.

17. The apparatus of claim 16, wherein the network address is an internet protocol address and wherein the channel number is encoded in a portion of the internet protocol address.

18. The apparatus of claim 17, wherein the channel number is determined from the internet protocol address by multiplying a third octet of the internet protocol address by 100 and adding the result to a fourth octet of the network protocol address.

19. The apparatus of claim 11, wherein the identified channel is included in a signal channel tuned by the signal receiving circuit, the signal channel including more than one channel with each channel containing a separate program stream.

20. A system comprising:
a user device that initiates a request to join a program stream at a network address over a local network based on a request for the program stream by a user; and
a multichannel content distribution device, coupled to the user device through the local network, the multichannel content distribution device including a set of tuners capable of simultaneously tuning different channels representing program streams that are broadcast from a service provider, the multichannel content distribution device receiving the request to join from the user device, identifying a channel associated with the network address, the channel being one of a plurality of channels received by the multichannel content distribution device, determining if the identified channel is already tuned by one of the set of tuners, tuning the identified channel using a tuner from the set of tuners that is not currently being used to tune one of the plurality of channels if it is determined that the identified channel is not already tuned, and providing the program stream from the tuned channel at the network address to the user device over the local network.
